(19) United States
(12) Patent Application Publication
(10) Pub. No.: US 2008/0183599 A1
(43) Pub. Date: Jul. 31, 2008

(54) Inventory control and communication system

(75) Inventors: Gordon W. Hill, Arlington, MA (US); John D. Lloyd, Hull, MA (US); Lawrence W. Hill, North Eastham, MA (US); Matthew M. Besen, Andover, MA (US)

Correspondence Address: WEINGARTEN, SCHURGIN, GAGNEBIN & LEBOVICI LLP, TEN POST OFFICE SQUARE, BOSTON, MA, 02109, US

(73) Assignee: VISIBLE INVENTORY, INC., Salem, NH (US)

(21) Appl. No.: 12/006,797

(22) Filed: Jan. 4, 2008

Related U.S. Application Data
(63) Continuation-in-part of application No. 10/453,451, filed on Jun. 3, 2003.
Application No. 10/453,451 is a continuation-in-part of application No. 09/442,889, filed on Nov. 18, 1999, now abandoned.
(60) Provisional application No. 60/108,843, filed on Nov. 18, 1998.
(60) Provisional application No. 60/136,297, filed on May 27, 1999.

(51) Int. Cl. G06Q 10/00

(52) U.S. Cl. 705/28

(57) ABSTRACT

An inventory control and communication system provides automated real-time control of stock levels and ordering in a timely manner so that optimal stock levels are maintained. An inventory sensor that includes a storage unit, or bin, for each stock item or inventory object. One or more transducers are associated with each storage unit to produce a mass/weight signal indicative of the weight of the stock items stored in or at the corresponding storage unit. The signals are transmitted to a computer associated with the inventory sensor, which determines the weight and the number of the inventory objects present in the bin and provides this data as part of the inventory data associated with the inventory object. The inventory data is provided to a host computer that maintains information about the inventory sensor location and the corresponding stock item, such as item weight and supplier information. Threshold values for the minimum and maximum quantity of each stock item are also maintained by the host computer. When the quantity of a stock item reaches the minimum threshold, the host computer is operative to send an order to the supplier to restore the stock item to the maximum quantity threshold, or otherwise indicates that a reorder is needed.

### CROSS REFERENCE TO RELATED APPLICATIONS

This application claims priority to U.S. provisional patent applications No. 60/108,843, filed Nov. 18, 1998, entitled Inventory Management System, and U.S. provisional patent application No. 60/136,297, filed May 27, 1999, entitled Inventory Control and Communication System. This application is a continuation-in-part of utility patent application Ser. No. 10/453,451, filed Jun. 3, 2003, entitled Inventory Control and Communication System, which is a continuation-in-part of utility patent application Ser. No. 09/442,889, filed Nov. 18, 1999, entitled Inventory Control and Communication System (previously abandoned).

### STATEMENT REGARDING FEDERALLY SPONSORED RESEARCH OR DEVELOPMENT

Not Applicable

### BACKGROUND OF THE INVENTION

Inventory management systems are known which attempt to keep inventory of stock items at an optimal level based upon factors such as availability, possibility of price increase, lag time to reorder, and predictability of consumption rates. One such system is a Materials Requirements Planning (MRP) system, which is the primary manufacturing module of Enterprise Resource Planning (ERP) systems. Inventory ordering is performed through accurate forecasts of finished product demand and raw material availability, among other factors. Such systems, however, depend upon accurate market forecasting. Another inventory system is known as a “Kanban” system, in which stock items are maintained with minimum and maximum thresholds. When the minimum threshold is reached, enough stock is ordered to bring the quantity back up to the maximum threshold. Timely examination of the stock item level is required, however, to ensure that the stock does not run out, and to ensure timely notification to a supplier to effect delivery.

It would be beneficial, therefore, to provide an inventory measurement and management system which performs automatic replenishment of stock through real-time polling of stock item quantity to avoid the need for periodic manual inspection of quantity and the need to maintain accurate market forecasts.

It would also be desirable to provide a real-time, inventory measurement and management system that includes dynamic lot sizing to modify maximum quantity thresholds, replenish quantity thresholds, and/or critical quantity thresholds based on historical usage automatically.

It would further be desirable to provide a real-time, inventory measurement and management system that can provide display messages at the inventory sensor and/or at the item or inventory object level to alert users of order status or alternate storage locations of the same or suitable substitution items or inventory objects.

### BRIEF SUMMARY OF THE INVENTION

An inventory control and communication system provides automated real-time control of stock levels and ordering in a timely manner so that optimal stock levels are maintained. An inventory sensor includes a storage unit, or bin, for each stock item or inventory object and one or more transducers associated with each storage unit is/are operative to produce a mass/weight signal indicative of the weight of the stock items or inventory objects stored in or at the corresponding storage unit.

The mass/weight signals are transmitted to a computer associated with the inventory sensor, which determines the weight of the stock items or inventory objects in the storage unit; calculates therefrom the numerical quantity of the stock items or inventory objects present in the bin; and provides and/or records this count as part of the inventory data associated with the stock items or inventory objects.

The numerical quantity of the stock item or inventory object can be determined by a computer associated with the inventory sensor using the known or predetermined weight of the predetermined stock item or inventory object at the respective storage unit. Transducers, such as strain gauges, are disposed on or at each storage unit in such a manner so as to be sensitive to the weight of the stock items or inventory objects at or contained in or on the storage unit. Multiple transducers can be used to measure the weight of a single storage unit.

The inventory data are provided to a central inventory server and/or host computer that maintains the inventory data along with information about the inventory sensor location and the corresponding stock item, such as item weight and supplier, vendor, distributor, and/or manufacturer information. Threshold values for the minimum and maximum quantity of each stock item or inventory object are also maintained by the central inventory server and/or host computer. When the numerical quantity of a stock item or inventory object reaches a minimum threshold, the central inventory server and/or host computer is operative to locate the identical stock item or inventory object internally and/or to send an order or alert to the supplier or other designated destination or individual to restore the numerical quantity of stock items or inventory objects to the maximum quantity threshold or to some level between the minimum quantity and maximum quantity thresholds, or otherwise indicates that a reorder is needed.

The inventory measurement and management system is adapted to provide dynamic lot sizing whereby the minimum quantity and maximum quantity thresholds are automatically adjusted higher or lower based on historical usage, demand, and/or consumption data during a prescribed period of time, to more effectively manage the costs associated with maintaining an inventory.

The inventory measurement and management system further includes a message display feature at the inventory sensor, to alert warehouse personnel of order status, of another location of the same item or inventory object, and/or of the location of a suitable substitute item or inventory object.

### BRIEF DESCRIPTION OF THE SEVERAL VIEWS OF THE DRAWING

The invention will be more fully understood with reference to the following detailed description and drawings, of which:

FIG. 1 is a block diagram of the inventory control and communication system as defined by the present invention;

FIG. 2 is a context diagram of the system of FIG. 1;

FIG. 3 is a block diagram of the database and query GUI as used in the present invention;

FIG. 4 shows a block diagram of a storage transmission node;

FIG. 5 shows a flowchart of the storage transmission node logic;

FIG. 6 shows the packet structure of the transducer signal packet sent from the storage transmission node;

FIG. 7 is a block diagram of another embodiment of the inventory control system as defined by the present invention;

FIG. 8 is a block diagram of an inventory sensor suitable for use with the embodiment of the inventory control system depicted in FIG. 7;

FIG. 9 is a block diagram of a node controller suitable for use with the embodiment of the inventory control system depicted in FIG. 7;

FIG. 10 shows a front elevation view of an illustrative front panel for an inventory sensor computer; and

FIG. 11 shows a block diagram of a host computer and network of remote customer facilities.

### DETAILED DESCRIPTION OF THE INVENTION

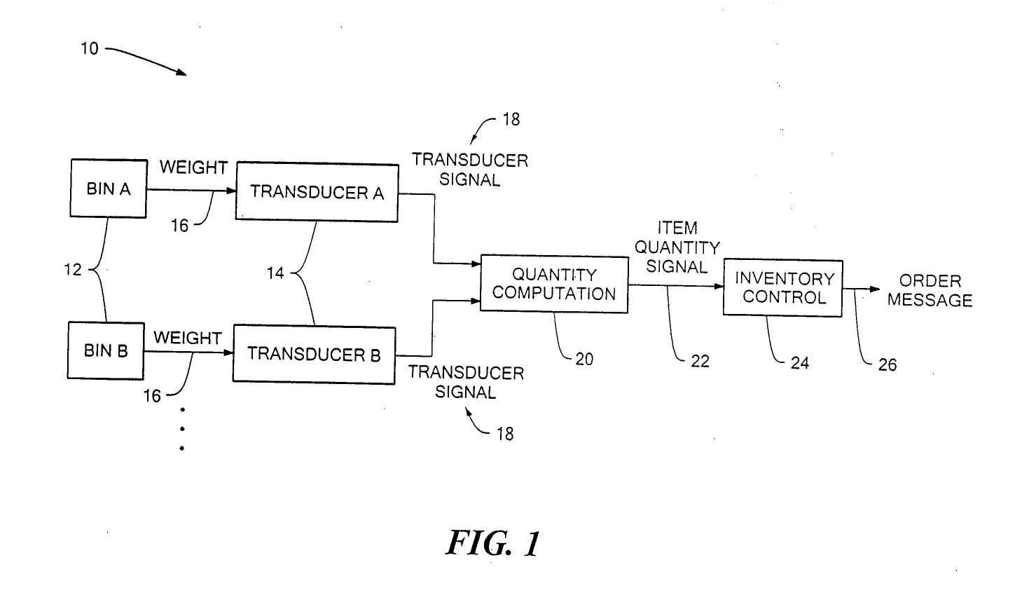

Referring to FIG. 1, a block diagram of the inventory control and communication system 10 is shown as defined herein. One or more storage units, such as bins 12, store a numerical quantity of a predetermined item or inventory object. The numerical quantity of the predetermined item or inventory object is proportional to the weight of the loaded bin 12. A transducer 14 senses the weight 16 of the bin 12, and produces a transducer signal 18 indicative thereof. The transducer signal 18 and the weight of the predetermined item or inventory object are then used by quantity computation 20 to compute the numerical quantity of the item or inventory object in, on or at the respective bin 12.

An item quantity signal 22 can be sent to inventory control 24 immediately once a change in inventory has occurred. Alternatively, the transducer 14 can be adapted to send an item quantity signal 22 after a certain number of items or inventory objects have been removed from the respective bin 12. For example, if there are 100 items in a bin 12 and the replenishment quantity is five, the transducer 14 can be adapted to send an item quantity signal 22 only after removal of 90 or more of the items or inventory objects from the respective bin 12.

The inventory control 24 compares the weight- or mass-based numerical quantity to predetermined maximum and minimum quantity thresholds for the particular item or inventory object. Minimum quantity thresholds can include a “replenishment” quantity threshold and a “critical” quantity threshold.

The predetermined replenishment quantity threshold corresponds to the item or inventory object quantity at which automatic ordering is performed in accordance with “normal” ordering procedures, to replenish the predetermined item or inventory object to a quantity between the replenishment quantity threshold and the maximum quantity threshold. Normal ordering procedures comply with standard operating procedures for ordering items periodically, e.g., at the end of the day or at the end of some other period, or, in instances in which the inventory measurement and management system 10 controls a multiplicity of warehouses or customer storage facilities that store similar items or inventory objects but that are remote from one another, when the total or combined number of the predetermined item or inventory object needed by all of the warehouses or storage facilities reaches a predetermined order quantity. Such bulk ordering for multiple warehouses or customer facilities can reduce unit price and shipment costs.

The critical quantity threshold corresponds to the item or inventory object numerical quantity at which extraordinary, abnormal ordering is performed, to replenish the predetermined item or inventory object to a quantity between the replenishment quantity threshold and the maximum quantity threshold. Extraordinary ordering can occur immediately and can include approval or authorization for rush delivery and/or authorization to send all or some portion of the necessary quantity as soon as possible.

For either minimum threshold, if the numerical quantity of a particular item or inventory object is below the minimum threshold, inventory control 24 sends an external order message 26 to a supplier, distributor, vendor, manufacturer, and the like and/or an internal order message 26 to an internal client, e.g., another warehouse or customer facility, to restock the item or inventory object.

The inventory control 24 and/or the quantity computation 20 can also be adapted to determine when an inventory sensor is not transmitting data. For example, if a transducer signal 18 is not received during a predetermined period of time appropriate for the item or inventory object owing to its historical demand or consumption, the inventory control 24 can generate a prompt to the respective inventory sensor to query the inventory sensor as to its status.

The inventory control 24 and/or the quantity computation 20 can further be adapted to determine when an item(s) or inventory object(s) from a first storage unit 12 or some other foreign object has/have fallen into a second storage unit 12. For example, if a widget from a first storage unit were to fall into a second storage unit, when the quantity computation 20 calculates the numerical quantity of the items or inventory objects in the second storage unit 12, the added widget will produce a not insubstantial mathematical remainder as long as the difference in the weight of the widget is significantly different than the weight of the item or inventory object in the second storage unit 12.

Once the quantity computation 20 identifies the existence of a not insubstantial mathematical remainder, the inventory control 24 and/or quantity computation 20 can generate a message to the respective inventory sensor for display on the front panel of the inventory sensor. The displayed message will alert the user to visually inspect the storage unit 12 for any non-conforming items or inventor objects.

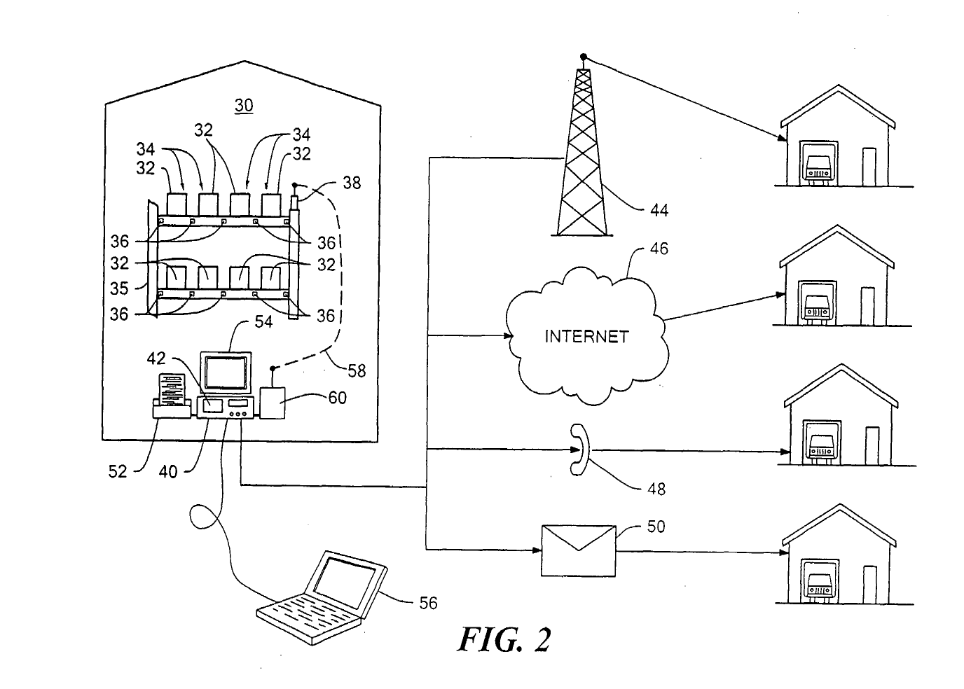

Referring to FIGS. 1 and 2, the inventory control and communication system 10 as described above is shown in the context of a customer facility 30. A plurality of storage units 32 is located at a facility 30, such as a warehouse or manufacturing site. Each storage unit 32 is adapted to store a numerical quantity of a predetermined item or inventory object 34 of a known or predetermined weight. The storage units 32, described further below, can be bins, pallets, shelves, fluid tanks, wire spools, or other storage apparatus, and can be mounted in rows on a rack 34 or free standing, depending on the items or inventory objects so stored.

One or more transducers 36 are associated with each storage unit 32, and are located so as to sense the weight of the stored items or objects 34. Each transducer 36 is connected to a storage transmission node 38, described further below, and is structured and arranged to send to the storage transmission node 38 a transducer signal 18 indicative of weight of the items or inventory objects in, on or at the storage unit 32 or, alternatively, to send a transducer signal 18 indicative of the numerical quantity of items or objects 34 in the storage unit 32. If signals 18 indicative of the numerical quantity of the items or objects 34 are transmitted instead of signals indicative of the total weight of the items or inventory objects 34 in the storage unit 32, then processors and memory storage for calculating the numerical quantity of items or objects 34 are needed at the storage unit 32 level.

The storage transmission node 38 builds a transducer signal packet including one or more transducer signals according to a predetermined protocol. The transducer signal packet is sent to a central inventory server 40, which receives transducer signal packets from other storage transmission nodes 38 at the facility 30. The central inventory server 40 uses the transducer signal packets to compute the numerical quantity of the items or objects 34 remaining in each of the storage units 32 (if the storage units 32 are not adapted to do so before signaling to the storage transmission nodes 38), and, further, compares these numerical quantities with minimum and maximum quantity thresholds that have been predetermined and stored in an inventory database 42.

The central inventory server 40 is connected to or otherwise accessible to the inventory database 42. the inventory database 42 stores information about the item or inventory object 34 corresponding to each storage unit 32. For example, for each storage unit 32, the item database 42 can include: the unit weight of the item or inventory object 34 stored therein, a replenishment quantity threshold, a critical quantity threshold, and a maximum quantity threshold for each item or inventory object 34. The inventory database 42 can also contain supplier, vendor, distributor, and/or manufacturer contact and order information for each item or inventory object 34. These data can include, for example and without limitation, mailing addresses, electronic mailing addresses, Web site addresses, telephone numbers, and so forth. The inventory server 40 is structured and arranged to send an order to the supplier, vendor, distributor, and/or manufacturer by any suitable means, such as via Internet 46, e.g., by electronic mail, voice communication 48, cellular or wireless communication 44, and/or via paper mail 50 by printing an order on the attached printer 52. Alternatively, the inventory server 40 can send quantity information without requesting an order.

The inventory server 40 has a graphical user interface (GUI), described further below, for performing various inventory query functions. The GUI can be accessed locally through the server monitor 54, or accessed remotely from another computer 56 or by a network host computer.

Referring to FIG. 11, a plurality of customer facilities 30 and their respective central inventory servers 40 can be structured and arranged into a network 70 that is controlled by a host computer 75. Such a network 70 would enable another level of management and control by which the inventories of plural customer facilities 30 can be centrally managed, offering the ability to adjust numerical quantity of items or inventory objects 34 internally using internal suppliers, i.e., other customer facilities 30 in the network 70, rather than having to order the items or inventory objects 34 from an external source. By allocating resources internally first, the host computer 75 can minimize inventory on hand and reduce unit costs and shipping expenses by ordering and purchasing items or objects 34 in bulk.

When a network 70 having a host computer 75 is used, some portion or all of the data stored in each of the inventory databases 42 can, instead, be centralized in a master database 78. Thus, the master database 48 can include information on the weight of each item or object 34 stored in each storage unit 32 and the replenishment, critical, and maximum quantity thresholds for each item or object 34. Real-time measured numerical quantities of each item or object 34 in each storage unit 32 at each facility 30 as well as supplier, vendor, distributor, and/or manufacturer contact and order information for each item or object 34 also can be stored in the master database 78. As a result, ordering to replace item or object 34 shortages can be centralized so that the shortage can be satisfied internally first before ordering through an external supplier, vendor, distributor, and/or manufacturer.

### Transducer Polling

As indicated above and as shown in FIG. 2, each strain gauge 36 is connected to a storage transmission node 38 local to the storage units 32. Each storage transmission node 38 can be connected to strain gauges 36 corresponding to multiple storage units 32. Readings from each of the strain gauges 36 are transmitted to the central inventory server 40 after building a signal packet at the storage transmission node 38.

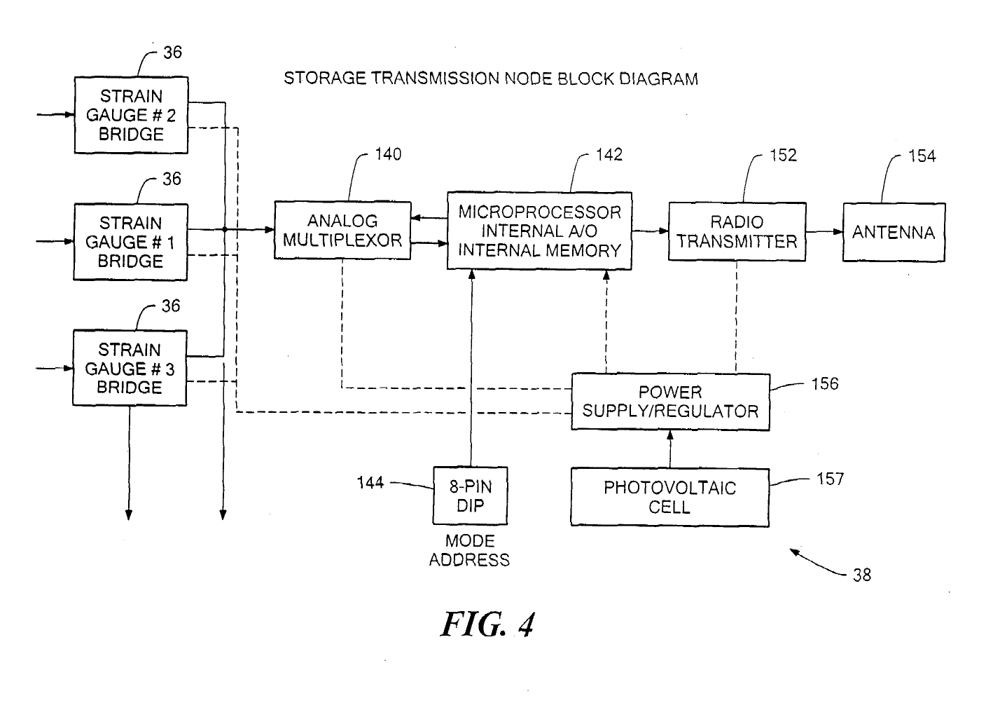

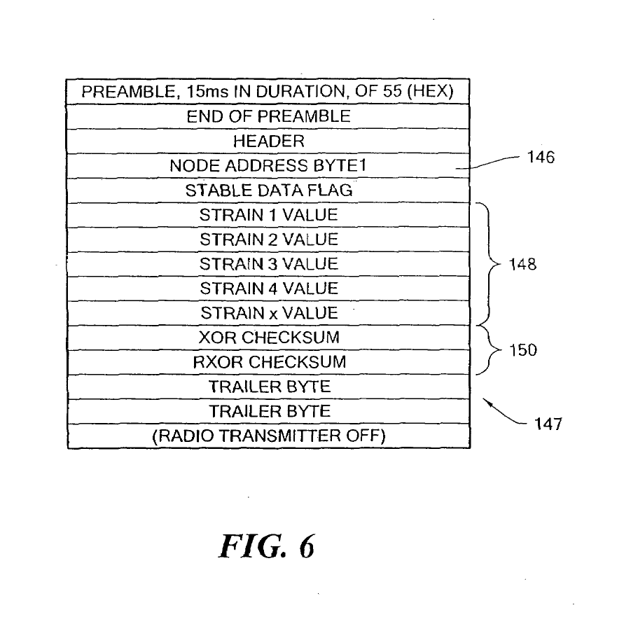

Referring to FIG. 4, a block diagram of the storage transmission node 38 is shown. Each strain gauge 36 is connected to a multiplexer 140. Multiplexer 140 polls each strain gauge 36 and sends the signals to the processor 142. The processor 142 builds a transducer signal packet containing the transducer signals. A node address, identifying the storage transmission node 38, is read from a DIP switch 144. The node address distinguishes multiple storage transmission nodes 38 which may be sending transducer signal packets to the central inventory server 40. An exemplary transducer signal packet 147 is shown in FIG. 6, and includes the node address 146, values for each strain gauge reading 148, and checksum fields 150.

The transducer signal packet 147 is sent to a radio transmitter 152 for transmission to the central inventory server 40 through an antenna 154. The storage transmission node 38 is powered through a power supply/regulator 156, which may include a photovoltaic cell 157.

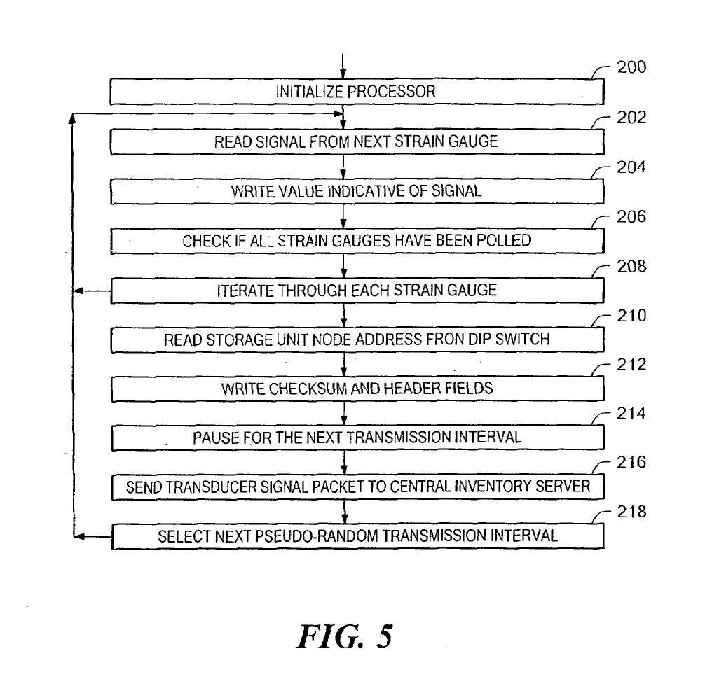

A flowchart of the storage transmission node 38 logic is shown in FIG. 5. The processor 142 is initialized at step 200 to begin polling at the first strain gauge. The signal from the next strain gauge is read, as depicted at step 202. A value indicative of the signal is written to the proper position in the transducer signal packet 147, as shown at step 204. A sampling algorithm may be employed to provide verification through multiple successive reads. A check is made, as disclosed at step 206 to determine if all strain gauges have been polled. If not, iterate through each strain gauge in sequence, as depicted in step 208. When all strain gauges have been read, the storage transmission node address is read from DIP switch 144, as depicted in step 210. Checksum and header fields are written to the transducer signal packet 147, shown in step 212. A pause for the next pseudo-random transmission interval is performed, as disclosed in step 214 and described further below. When the transmission interval elapses, the transducer signal packet 147 is sent to the central inventory server 40, as shown in step 216. The next pseudo-random transmission interval is selected, as shown at step 218, and control reverts to step 202.

### Signal Packet Transmission

On a periodic basis, as indicated above with respect to FIG. 1, each storage transmission node 38 polls each transducer 36 connected to it in sequence to cause the transducer 36 to send the transducer signal 18. Each storage transmission node 38, after polling each transducer 36, builds and sends the transducer signal packet 147 to the central inventory server 40 and/or the host computer 75. In a preferred embodiment, transmission to the inventory server 40 and/or the host computer 75 is via a RF link 58 to an RF receiver 60, but can be by any suitable means, such as Internet, power line, modem, LAN, WAN, IR, wireless communication or other communication link.

Typically there will be a plurality of storage transmission nodes 38 at each facility 30. Each storage transmission node 38 will be sending periodic transducer signal packets 147 containing the latest transducer polling sequence. Transmission intervals to the inventory server 40 and/or to the host computer 75 are therefore staggered pseudo-randomly, to avoid collisions between simultaneous transducer signal packets 147. Collisions which do occur, however, are unlikely to repeatedly affect the same storage transmission node 38, due to the pseudo-random staggering. Since the pseudo-random staggering makes it unlikely that a collision will repeatedly affect the same transmission node 38, subsequent transducer signal packets 147 will ensure that the numerical quantity counts remain current.

If a storage transmission node 38 does not transmit data in accordance with its transmission interval, the central inventory server 40 and/or the host computer 75 can generate a prompt to the storage transmission node 38 and/or to the delinquent inventory sensor, to query the storage transmission node 38 and/or inventory sensor as to its status. In this fashion, non-operating inventory sensors, transducers, and/or storage transmission nodes 38 can be made operational.

In a preferred embodiment, the storage transmission nodes 38 comprise transmit only radios 152. Such radios 152 do not require a two way protocol, therefore saving bandwidth. Accordingly, a pseudo-random interval avoids collisions without requiring a duplex protocol. Further, the interval determination uses the address of the storage transmission node 38, ensuring that two storage transmission nodes 38 will not collide on consecutive cycles.

Referring again to FIGS. 1 and 6, upon receipt by the central inventory server 40 and/or the host computer 75, the transducer signal packet 147 can be used to compute the numerical quantity of items or objects 34 stored in each storage unit 32 (unless the numerical quantity of the items or objects 34 were calculated at the inventory sensor level). For each storage unit 32, information concerning the corresponding storage transmission node 38, and the corresponding transducer signal values from the transducer signal packet (148 and 147 respectively, FIG. 6) are used to compute the total weight contained in or at the storage unit 32. The numerical quantity of the items or objects 34 in the storage unit 32 can then be determined based on the total weight and the known, individual item weight.

As previously mentioned in conjunction with the quantity computation 20, when calculating the numerical quantity of the items or inventory objects 34 in a particular storage unit 32, the inventory server 40 and/or host computer 75 can be adapted to identify the existence of a not insubstantial mathematical remainder that is indicative of the presence of some foreign object in storage unit 32. The inventory server 40 and/or host computer 75 can then generate a message to the respective inventory sensor for display on the front panel of the inventory sensor. The message can alert the user to visually inspect the storage bin 12 for any non-conforming items or objects.

The calculated numerical quantity of each item or object 34 is further compared to replenishment and critical minimum quantity threshold values, which can indicate when an order is to be generated. The comparison can take place at the inventory server 40 and/or at the host computer 75. When the numerical quantity falls below one or both of the minimum thresholds, the inventory server 40 and/or at the host computer 75 is adapted to generate an internal or external order, to replenish the numerical quantity of the item or object 34 to a level between the replenishment quantity and the maximum quantity for the item or object 34.

The inventory database 42 associated with the inventory server 40 and/or the database 78 associated with the host computer 75 includes supplier, vendor, distributor, and/or manufacturer contact information and order methods, such as Internet, electronic mail, paper mail, and/or wireless, cellular or public switched telephone, so that an order may be generated and sent automatically.

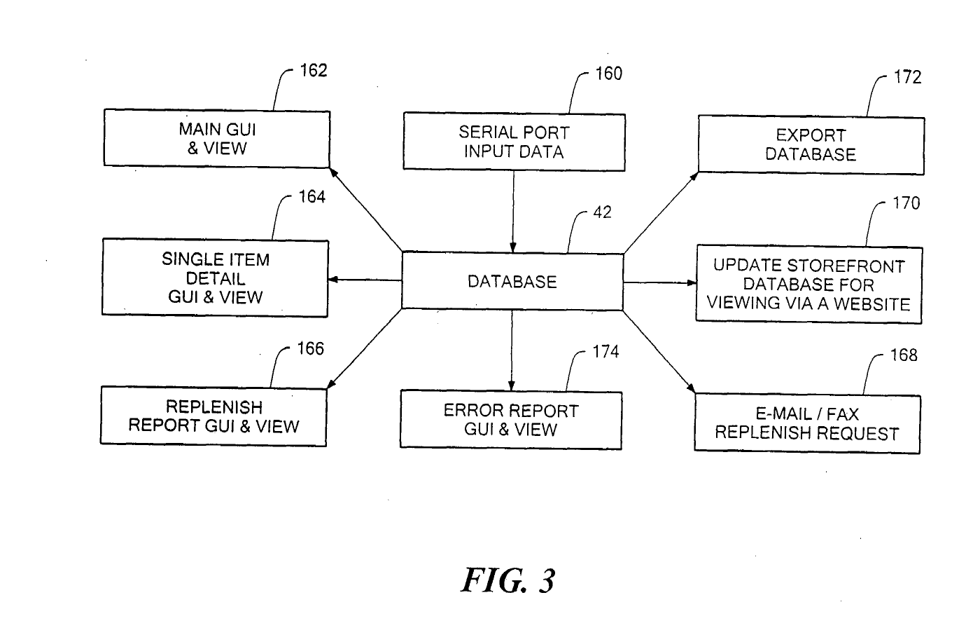

The inventory database 42 or 78 is also connected to a GUI for various user interactions, shown in FIG. 3. The database is populated through a serial port 160 from the receiver 60 (FIG. 1). A main view screen 162 provides options allowing a user to access the various functions enumerated below. A single item detail view 164 screen allows graphical information concerning quantity of individual parts in relation to the minimum and maximum quantity thresholds. A replenish report view screen 166 provides information concerning frequency of orders placed for a particular item. A replenish request view screen 168 allows a manual item order to be placed via e-mail or fax. A storefront view screen 170 allows remote Internet access. An export database view screen 172 allows downloading to a remote client. An error report view screen 172 provides diagnostic feedback about system functions. Other queries and access to the database can be envisioned in addition to those enumerated here.

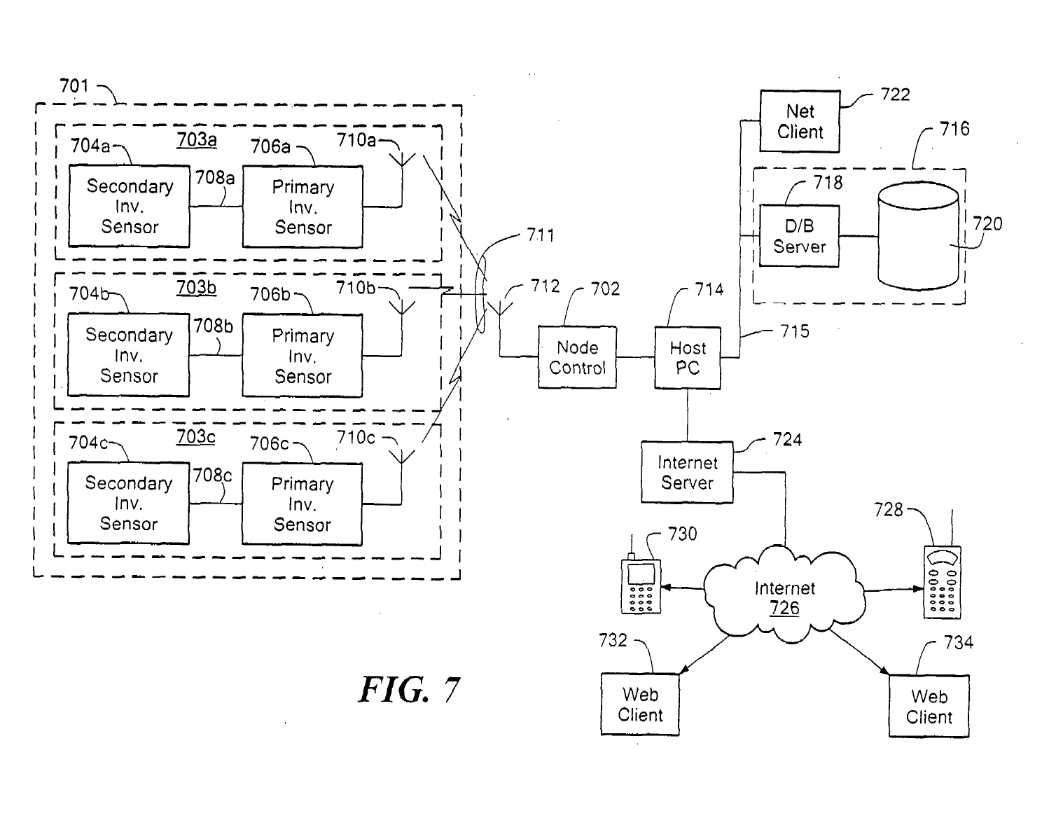

FIG. 7 depicts another embodiment of the inventory control system described herein. Inventory control system 700 includes an inventory sensor system 701 coupled to a node controller 702 via a primary sensor network 711. The node controller 702 is coupled to a host computer 714. The host computer 714 is coupled via a network 715 to a database system 716 that includes a database server 718 and a database storage device 720. One or more net clients 722 can be coupled to the network 715 to access the host computer 714 and retrieve and analyze data from the database system 716. The host computer 714 can also be coupled to an Internet server 724 and thereby coupled to the Internet 726. The host computer 714 can then provide e-mail alerts and orders or voice mail alerts and orders to users and suppliers, for example, via cell-phones 728, personal data assistants (PDAs) 730 or one or more web clients 732 and 734. In addition, the web clients 732, 734 and the net client 722 can access the host computer 714 and retrieve, analyze and process data from the database system 716 separately from the host computer 714.

The inventory sensor system 701 includes at least one networked inventory sensor, and in the illustrative embodiment there are depicted a plurality of network inventory sensors 703a, 703b, and 703c each of which includes one or more inventory sensors networked together. The one or more inventory sensors 703a, 703b, and 703c include(s) at least one primary inventory sensor and if more than one inventory sensor is present these are connected to the primary inventory sensor as secondary inventory sensors. In the embodiment depicted in FIG. 7, each of the plurality of network inventory sensors 703a, 703b, and 703c includes a primary inventory sensor 706a, 706b, and 706c, respectively, and a secondary sensor 704a, 704b, and 704c, respectively. Each secondary inventory sensor 704a-c is communicably coupled to the corresponding primary inventory sensor 701a-c, respectively via a corresponding sensor network 708a-c. When there are more than one secondary inventory sensor present within one of the networks of inventory sensors 701a-c, the additional secondary sensors can be coupled to the other second inventory sensors in that particular network of sensors and to the corresponding primary inventory sensor via the corresponding sensor network 708a-708c, respectively.

As will be explained below, each inventory sensor 703a, 703b, and 703c senses the weight of items or inventory objects 34 and provides inventory data relating to the type and numerical quantity of the items or inventory objects present at the respective sensor. As will be explained below, the respective inventory sensor 703a, 703b, and 703c can provide inventory data periodically or in a preferred embodiment, the inventory data is provided only after the weight of the corresponding inventory object changes. The inventory sensors 703a, 703b, and 703c also provide other data that are necessary for the control and operation of the respective sensor such as inventory sensor calibration and inventory sensor configuration data. Secondary inventory sensors 704a-c, provide this inventory data to the corresponding primary inventory sensor, 706a-c, respectively, via the corresponding inventory sensor network 708a-c, respectively. The primary inventory sensor 706a-c also provides inventory data as an output. The respective primary inventory sensor 706a-c combines the inventory data it has provided along with the inventory data received from the secondary inventory sensors 704a-c via the respective sensor network 708a-c. The respective primary inventory sensor 706a-c provides this combined inventory data to the node controller 702 via a primary sensor network 711.

The primary sensor network 711 interconnects each primary inventory sensor 706a-c with the node controller 702 to transfer inventory data from each sensor 706a-c coupled thereto, configuration and calibration data for the various sensors coupled thereto, and communicates commands and data to the various secondary inventory sensors 704a-c connected thereto. The primary sensor network 711 can interconnect each respective primary inventory sensor 706a-c using a variety of methods that can include, but are not limited to, wireless optical transmission, wireless RF transmission, optical network transmission, and electrical network transmission such as a LAN, a WAN or an Ethernet network.

In the embodiment depicted in FIG. 7 the master sensor network utilizes wireless RF data transmission to communicate data between the respective primary inventory sensors 706a-706c and the node controller 702. The RF data transmission used herein is between the wireless RF antenna 710a, 710b, and 710c coupled to the corresponding primary inventory sensor 706a, 706b, and 706c respectively, and a wireless RF antenna 712 coupled to the node controller 702. Although in the illustrative embodiment in FIG. 7 depicts each primary inventory sensor 706a-c being coupled via a wireless RF data signal to the node controller 702, various methods can be used to connect each individual primary inventory sensor 706a-c to the node controller 702. For example, primary inventory sensors 706a-c that are located closer to the node controller 702 can be coupled using a short range electrical or optical network or a free space optical signal. Primary inventory sensors 706a-c that are farther away from the node controller 702 can use wireless RF data signals or longer range LANS or WANs to interconnect to the node controller 702.

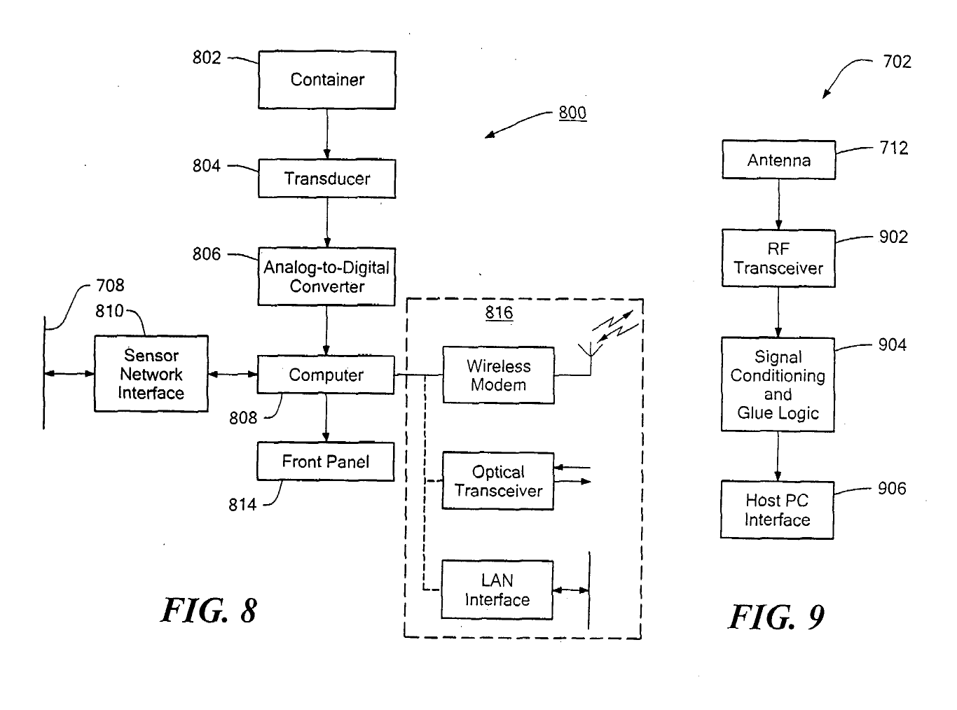

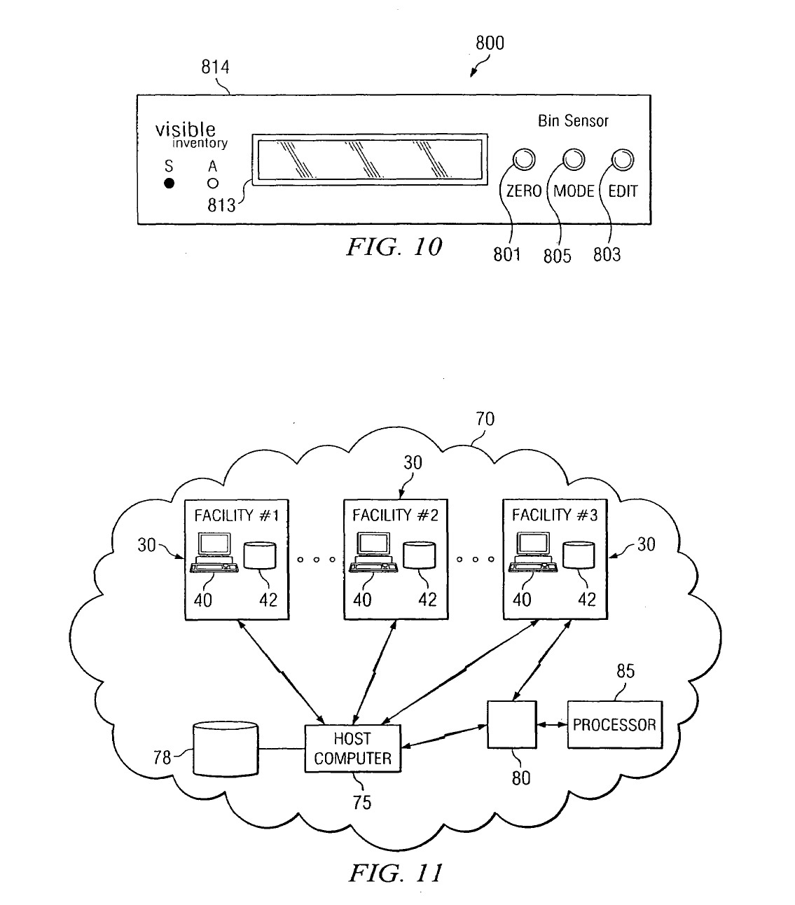

FIG. 8 and FIG. 10 depict an inventory sensor 800 suitable for use as a secondary inventory sensor or, with the addition of a primary network link, as a primary inventory sensor. A suitable inventory sensor 800 includes a bin 802 that contains a quantity of inventory objects (not shown) that are to be counted. The bin 802 rests on a transducer 804 that is capable of providing an electrical signal that is indicative of the mass/weight of the inventory objects that are present in the bin 802. The mass transducer 804 can be any suitable mass-sensing element known in the art. For example the mass transducer can be, without limitation a strain gauge, load cell, pressure sensor, optical sensor, liquid sensor, or sonic sensor that is capable of providing an electrical mass/weight signal having at least one characteristic that changes as a known function of the mass/weight of the inventory objects that are being measured.

The transducer 804 provides the output electrical mass/weight signal to an analog-to-digital converter 806 that can include, for example, front end processing, filtering, and signal conditioning of the electrical mass/weight signal provided by the transducer 804. The analog-to-digital converter 806 converts the analog electrical signal into a binary signal that is indicative of the weight/mass of inventory objects in the bin 802. The analog-to-digital converter provides the binary signal to the sensor's computer 808 for processing.

The computer 808 can be a microcomputer including a microprocessor or a microcontroller. The computer 808 is adapted to configure and calibrate the inventory sensor 800 to ensure an accurate weight- or mass-based numerical count of the items or inventory objects. More specifically, the computer 808 processes the binary mass/weight signal to determine the desired inventory data. For example, the computer 808 can be configured to continuously monitor and process the mass/weight signal but only to provide an output of inventory data after a change in the mass/weight signal has been detected and/or if a predetermined time period has elapsed since the last data output. By not transmitting inventory data periodically, the inventory sensor 800 uses less power and thus conserves battery life in the event that the inventory sensor 800 is battery powered. The inventory sensors 800 can be powered by on-site electrical power or by a battery power supply. The status of the on-site electrical power or the battery status can be included in the inventory data and stored in the database so that power monitoring of the inventory sensors 800 is available.

A settling time can also be included in each inventory sensor 800. The settling time is a dead-time period during which the computer 808 does not transmit inventory data even after a change in the mass/weight signal has been detected, to minimize false reporting. For example, a user removing inventory objects from a bin 802 may remove too many of the objects and then replace the extra inventory objects into the bin 802 after a brief period of time. The settling time prevents this occurrence from distorting the true count of the inventory objects.

The computer 808 includes a front panel 814 that includes a display portion 813. The display portion 813, e.g., an LCD or LED display, is operative to display predetermined user selected information such as inventory data, calibration data, and configuration data. In addition, messages sent to the respective inventory sensor 800 from the central inventory server 40 or, alternatively, from the host computer 714 can be displayed on the display portion of the front panel 814 as well. For example, sensor or inventory object level messages can be displayed on the display portion 813 to indicate to users that the inventory object has been ordered (to include an expected date of delivery) and/or to indicate to users other bin locations in the facility 30 to find the same inventory object or a suitable substitute inventory object.

The front panel 814 further includes one or more button controls 801, 803, and 805 to provide for user control of certain predetermined operations of the computer 808. For example, prior to use, the inventory system must be zeroed or tared so that the weight of the bin 802 is not included in the subsequent calculations. Typically a button controller 801 on the front panel 814 of the computer 808 is used to instruct the computer 808 to set the sensor output to zero before the user has added any inventory objects into the bin 802. Sensor calibration can then be accomplished by placing a known quantity of inventory objects into the bin 802; receiving the digital representation of the mass/weight of the inventory objects placed into the bin 802; and by entering the number of inventory objects that were placed into the bin 802 using appropriate button controls 801, 803, and 805.

This initial calibration procedure is necessary so that as the mass/weight changes due to the removal and replenishment of inventory objects, an accurate count of the inventory objects can be maintained. The display portion of the front panel can be used to display data relating to the operation of the sensor, such as the mass/weight of the inventory objects currently in the bin 802, the description of the inventory objects in the bin 802, the quantity of objects contained in the bin 802, the status of the particular sensor 800, and any necessary configuration data.

The sensor 800 further includes an interface 810 to the sensor network 708 so that data regarding the operation of the sensor 800 including inventory data and status and configuration data can be provided to other sensors and, in the event that the sensor is a secondary sensor, to the corresponding primary inventory sensor. In a preferred embodiment, the sensor network 808 is the I²C Bus developed by Philips Corp. Information regarding the I²C Bus can be found at www.philipslogic.com/i2c and the corresponding handbook, application notes, application, and design support may be found at www.semiconductors.philips.com/i2c. The I²C bus is a two-wire bus for controlling and monitoring applications in computing, communications, and manufacturing environments. In the illustrative embodiment, there can be 24 secondary inventory sensors and one primary inventory sensor in a single networked sensor system. Other networks can be used, for example other multi-drop bus architectures, TDMA buses, or and RS-485 bus architecture can be used. In general parallel busses are not optimal in this system so that serial busses are preferred.

In the event that the sensor 800 is to be a primary inventory sensor, the basic sensor will have attached to the computer 808, a primary network link interface 816. The primary network link interface 816 couples the corresponding primary inventory sensor 706a-c to the node controller 702. In the illustrative embodiment, a wireless RF duplex modem is used to communicate between the primary inventory sensor and the node controller. The duplex wireless modem includes an RF transceiver at both the respective primary inventory sensor and the node controller to send and receive digital data transmissions to and from the node controller respectively. The wireless modems communicate via signals sent and received via antennas 710a-c and 712. In the illustrative embodiment, each transmission is acknowledged by the receiving system. Alternatively, a wireless optical communications system can be used that includes a separate optical transceiver that is coupled to each individual primary inventory sensor and one that is coupled to the node controller. In another embodiment, a network, either electrical or optical, can be used to coupled the primary inventory sensors to the node controller. The network can be a LAN, Ethernet, WAN, or other suitable electrical or optical network. A suitable sensor is the iSeries sensor products available from Visible Inventory, www.visibleinventory.com.

The node controller 702 is depicted in greater detail in FIG. 9. The node controller 702 includes an interface 902 to the primary inventory sensor network that coupled the primary inventory sensors 706a-c to the node controller 702 as depicted in FIG. 7. In the illustrative embodiment, the interface is a wireless RF modem having an antenna 712 coupled to a radio transceiver 902. Signal conditioning circuitry and glue logic 904 couple the wireless modem to the external network connection 906 where inventory data 714 is provided to external computers and database systems. The signal conditioning circuitry and glue logic 904 condition data that are both received at and that are to be transmitted by the interface 902. Although in the illustrated embodiment the interface 902 is a wireless RF connection, the interface must be mutually compatible with the primary inventory sensor network 711. Thus, in addition to a wireless RF interface, the interface 902 can be an optical or electrical interface as well.

The host computer 714 provides the interface to the stored data. The host computer 714 receives the inventory data and other sensor data from the node controller 702 and stores the data in a database system 716. The database system 716 typically includes a database server 718 and a database storage device 720 where the inventory data and sensor data are stored. The stored data can include various data fields associated with a particular inventory sensor. For example, the data can include the current numerical quantity of the inventory object, the part-number of the corresponding inventory object, a description of the inventory object, the location of the inventory sensor 800 within the customer facility 30, the part status, and specific instructions, such as re-ordering instructions, e-mail addresses, and set forms to send to the desired recipients. In addition, data are associated with each inventory object and stored in the database system 716. This associated inventory object data can include suppliers, vendors, distributors, and/or manufacturers of the inventory object, the re-order quantities of the inventory object, the replenishment levels of the inventory object, the over-stock levels of the inventory object, the order lead times, the critical quantity levels of the inventory object, and the maximum quantity level of the inventory object.

The host computer 714 is able to update the inventory data associated with the inventory objects at each inventory sensor 800 in the database system 716 continuously as the respective inventory data are received. Thus, the inventory data stored on the database system 716 can be processed in real-time or pseudo-real time. This processing, which may be performed by the host computer 714 or a net client 722 coupled via network 715 or a web client 732, 734 coupled via the Internet 726 and web server 724, can include comparing the numerical quantity levels of the inventory objects to predetermined threshold levels so that alerts or automatic orders of the particular inventory object can be initiated when quantities of the inventory object fall below the previously determined critical or replenishment levels.

As noted above, the host computer 714 can be coupled to the Internet 726 via an Internet server 724 allowing web based clients 732 and 734 access to the stored inventory data via the host computer 714. In addition, in response to the inventory data stored in the database system 716, the host computer 714, web clients 732, 734, or network client 722 can automatically provide e-mail notification or other voice messaging to cellular telephone users 728, PDA users 730, or other net clients or web-based clients of various real-time situations. These real-time situations can relate to particular inventory objects reaching replenishment levels, critical levels, or over-stock levels. In addition, the host computer 714, the net client 722, or web clients 732, 734 can automatically e-mail suppliers, vendors, distributors, and/or manufacturers to re-order predetermined specific amounts of the particular inventory object associated with the particular inventory object and stored in the database system 716 as described above. Also, the host computer 714, net client 722 or web client 732, 734 can provide users with graphical or textual data regarding the current status of each inventory object. Data can be color coded to visually alert users to varying conditions within the inventory sensor network. These conditions can relate to both inventory levels and inventory sensor status. In addition, historical inventory data may be used and analyzed to enable the optimization of the required quantities of the inventory objects. A suitable software package for the host computer and also the net and web clients is the SuppliLink Software available from Visible Inventory, www.visibleinventory.com.

Those skilled in the art should readily appreciate that the programs defining the functions described herein can be delivered to a computer in many forms, including, but not limited to: (a) information permanently stored on non-writable storage media (e.g., read-only memory devices within a computer such as ROM or CD-ROM disks readable by a computer I/O attachment; (b) information alterably stored on writable storage medial (e.g., floppy disks, tapes read/write optical media and hard drives); or (c) information conveyed to a computer through a communication media, for example, using baseband signaling or broadband signaling techniques, such as over computer or telephone networks via a modem. The present embodiments may be implemented in a software executable out of a memory by a processor. Alternatively, the presently described functions may be embodied in part or in whole using hardware components such as Application Specific Integrated Circuits (ASICs), state machines, controllers or other hardware components or devices, or a combination of hardware components and software.

### Dynamic Lot Sizing

Although minimum and maximum quantity thresholds can be predetermined, the disclosed measurement and management control system further or optionally includes means for automatically and dynamically modifying these minimum and maximum quantity thresholds based on, for example, demand or consumption of each item or inventory object over a predefined period of time. This process is referred to as dynamic lot sizing. Dynamic lot sizing is an intelligent process that ensures, on one hand, an adequate inventory while, on the other hand, minimizes the carrying cost of overstocked inventory objects.

The means for automatically and dynamically modifying the minimum and maximum quantity thresholds can be structured and arranged as hardware components such as Application Specific Integrated Circuits (ASICs), state machines, controllers or other hardware components or devices, or a combination of hardware components and software. For example, referring to FIG. 11, the means for automatically and dynamically modifying the minimum and maximum quantity thresholds 80 can be implemented using the host computer 75, using the central inventory server 40, and/or using a separate processor 85. The means for automatically and dynamically modifying the minimum and maximum quantity thresholds 80 is electrically coupled to the at least one of the inventory sensors, the central inventory server 40, and the host computer 75. Moreover, the means for automatically and dynamically modifying the minimum and maximum quantity thresholds 80 is electrically coupled to a memory storage device and/or to memory storage devices 42 associated with the central inventory server 40 and/or memory storage devices 78 associated with the host computer 75.

Having described means for automatically and dynamically modifying the minimum and maximum quantity thresholds 80, dynamic lot sizing will now be described. During initialization or start-up, users can artificially predetermine minimum and maximum quantity thresholds for each item or inventory object. During start-up users can also specify a period of time or window, e.g., 30-, 60- or 90-day window, over which the means for automatically and dynamically modifying the minimum and maximum quantity thresholds 80 will determine and record the demand or consumption of each item or inventory object during the window. The window can also be structured and arranged as a sliding scale whereby the period of time having experienced the greatest demand or consumption of the item or inventory object is used to modify the minimum and maximum quantity thresholds rather than the demand or consumption during the most recent period of time.

If the actual demand or consumption during the window is less than the predetermined minimum and maximum quantity thresholds, the minimum and maximum quantity thresholds can be modified downwards or left alone. However, if the actual demand or consumption during the window is greater than the predetermined minimum and maximum quantity thresholds, the minimum and maximum quantity thresholds can be modified upwards to reflect the need to have more of the inventory objects on hand.

The means for automatically and dynamically modifying the minimum and maximum quantity thresholds 80 can also be adapted to record delivery times and rush delivery times for each of the suppliers, vendors, distributors or manufacturers so that, in modifying any of the minimum or maximum quantity thresholds, the means 80 can also take into account the turn-around time from order to delivery.

The means for automatically and dynamically modifying the minimum and maximum quantity thresholds 80 can also be adapted to account for seasonal variations in demand and consumption. For example, using a sliding-scale, 90-day sampling window, the means for automatically and dynamically modifying the minimum and maximum quantity thresholds 80 can determine the demand or consumption for each 90-day window. When historical data for a period of years is available, these data can be used to compare the maxima and minima, to identify seasonal trends by which the minimum and maximum quantity thresholds can be modified. Those of ordinary skill in the art should further appreciate that variations to and modification of the above-described methods and apparatus for providing automated inventory computation and ordering may be made without departing from the inventive concepts disclosed herein. Accordingly, the invention should be viewed as limited solely by the scope and spirit of the appended claims.

1. A system for determining the numerical quantity of at least one inventory object comprising:
at least one inventory sensor operative to provide inventory data corresponding to said inventory objects associated with said inventory sensor, wherein each of said at least one inventory sensor includes a storage unit adapted to store a quantity of a predetermined item of known weight;
a database system that includes stored data on a unit weight of each predetermined item in each storage unit; and
a host computer coupled to the sensor and operative to receive said inventory data, said host computer further coupled to said database system,
wherein said host computer is operative to store said inventory data in said database system, and wherein said host computer is operative to process said inventory data and to provide output messages regarding said status of said inventory object, and wherein said host computer is operative to compute said inventory data of said quantity of a predetermined item in said storage unit using said known weight.

2. The system of claim 1 wherein the at least one inventory object is a plurality of inventory objects and wherein the at least one inventory sensor is a plurality of inventory sensors, each inventory sensor corresponding to one of said plurality of inventory objects, and wherein one of said plurality of inventory sensors is a primary inventory sensor and the remaining are secondary inventory sensors, and wherein the secondary inventory sensors are connected via a sensor network to one another, and to said primary inventory sensor, and wherein said primary inventory sensor combines said inventory data from each secondary inventory sensor with said primary inventory sensor inventory data and wherein said primary inventory sensor is coupled to said host computer and provides said combined inventory data thereto.

3. The system of claim 1 wherein each inventory sensor of the least one inventory sensor includes:
a transducer associated with the storage unit and operative to provide a transducer signal indicative of the mass of the quantity of a predetermined item stored in said storage unit; and
a computer operable to receive said transducer signal from said transducer,
wherein said computer is further operable to compute said inventory data of said items in said storage unit using said transducer signal and the known unit weight of the predetermined item.

4. The system of claim 3 wherein said transducer signal is produced at regular, periodic intervals according to predetermined logic.

5. The system of claim 3 wherein said inventory data is computed at regular, periodic intervals according to predetermined logic.

6. The system of claim 3 wherein said inventory data is provided to said host computer only after a change in the transducer signal.

7. The system of claim 3 wherein said computer in said inventory sensor defines a settling time associated with the respective inventory sensor wherein said settling time is a dead-time after a change is detected in said transducer signal during which said inventory data is not provided to said host computer.

8. The system of claim 1 further comprising an RF link operable to transport said inventory data from said primary inventory sensor to said host computer.

9. The system of claim 1 further including a network interface coupled to said host computer and to a network and said host computer operative to send an order via e-mail over said network to a supplier, wherein said order is sent when said quantity equals a predetermined threshold.

10. The system of claim 2 wherein said transducer signal is a voltage signal proportional to said weight of said items.

11. The system of claim 1 wherein said transducer is selected from the group consisting of a strain gauge, a piezoelectric sensor, load cell, optical sensor, and a pressure sensitive resistor.

12. The system of claim 1 wherein said inventory data includes a list indicative of which of said predetermined stock corresponds to each of said storage units, and further indicative of which of said transducers corresponds to each of said storage units.

13. The system as in claim 1 wherein said transducer is mass sensitive.

14. The system as in claim 3 wherein said storage unit is selected from the group comprising an open top bin, a pallet, and a tank adapted to store fluid.

15. The system as in claim 3 wherein said storage unit is an elongated cylindrical shape adapted to store a spool in rotational communication therewith.

16. The system as in claim 3 wherein said inventory sensor further includes a display capable of displaying predetermined data and messages.

17. The system as in claim 3 wherein said inventory sensor further includes switches coupled to said computer and operative to initiate a predetermined program.

18. The system as in claim 17 wherein said predetermined program is a zero calibration routine or an inventory sensor calibration routine.

19. The system as recited in claim 1, wherein the database system includes stored data on at least one of a maximum quantity threshold and a minimum quantity threshold for each predetermined item in each storage unit and the host computer is further adapted to compare said inventory data with at least one of the maximum quantity threshold and the minimum quantity threshold.

20. The system as recited in claim 1, wherein the database system includes stored data on supplier information for each predetermined item in each storage unit.

21. The system as recited in claim 1, wherein the host computer is further adapted to automatically send at least one of quantity information and a requisition order for a specified quantity of said predetermined item to at least one of a supplier, a client or a user via a communication network.

22. The system as recited in claim 1, wherein the communication network includes a public switched telephone network, a local area network, a wide area network, electronic mail, voice mail, wireless communication, the Internet, and/or the Ethernet.

23. The system as recited in claim 1, wherein each of the at least one inventory sensor includes a front panel with a display portion that displays messages that include at least one of:
an order status of the inventory object;
an alternate location of the inventory object; and/or
a location of an acceptable substitute to the inventory object.

24. The system as recited in claim 1, further comprising means for automatically and dynamically modifying at least one minimum and maximum quantity threshold for each of the at least one inventory object using demand or consumption of said at least one inventory object during a predetermined period of time.

25. The system as recited in claim 24, wherein the means for automatically and dynamically modifying at least one minimum and maximum quantity threshold is a sliding scale.

26. A method of inventory management for automatic replenishment of stock items through real-time inventory calculation comprising:
providing a storage unit adapted to store a quantity of a predetermined item of a known weight;
disposing a transducer operable to provide a transducer signal indicative of the weight of said storage units;
providing said transducer signal;
computing, from said transducer signal and said known weight inventory data including the quantity of predetermined stock items stored at said storage units.

27. The method as in claim 26 further comprising the steps of transmitting, to said host computer, said inventory data.

28. The method of claim 26 wherein said step of transmitting is followed by comparing said inventory data to a predetermined threshold.

29. The method of claim 28 further comprising sending an order to a supplier when said quantity equals said predetermined threshold.

30. The method of claim 26 wherein said step of computing is performed at regular, periodic intervals according to predetermined logic.

31. The method of claim 26 wherein said step of transmitting to said central inventory server is via an RF link.

32. The method of claim 26 further comprising:
performing dynamic lot sizing on demand and consumption data for each of the at least one inventory objects, wherein dynamic lot sizing includes automatically and dynamically modifying at least one minimum and/or maximum quantity threshold of said at least one inventory object using demand and consumption data for a predetermined period of time.

33. The method of claim 26 further comprising displaying at the storage unit at least one of the following:
an order status of the inventory object;
an alternate location of the inventory object; and/or
a location of an acceptable substitute to the inventory object.
